(19) United States
(12) Patent Application Publication
(10) Pub. No.: US 2023/0151921 A1
(43) Pub. Date: May 18, 2023

(54) APPARATUS AND METHOD FOR LOADING A PIG INTO A PIPELINE WITH PIPELINE-ENGAGING MOVABLE MEMBER, REMOVABLE REDUCER, AND HYDRAULIC CYLINDER

(71) Applicant: Warren Peterson, Rocky Mountain House (CA)

(72) Inventor: Warren Peterson, Rocky Mountain House (CA)

(21) Appl. No.: 17/988,070

(22) Filed: Nov. 16, 2022

Related U.S. Application Data
(60) Provisional application No. 63/280,947, filed on Nov. 18, 2021.

(51) Int. Cl. F16L 55/46

(52) U.S. Cl. CPC F16L 55/46

(57) ABSTRACT

An apparatus for loading a pig into a pipeline includes a support member for engaging the cylindrical pipeline outer surface to support the apparatus on the pipeline, a tubular reducer, a force-transmitting member with a pig-engaging surface, and a guide member that is attached to the support member and permits axial movement of the force-transmitting member relative to the reducer. The apparatus includes outer and inner pipeline-engaging members attached to the force-transmitting member and disposed to engage the pipeline outer surface and the pipeline outer and inner surfaces, respectively, to brace a portion of the attached force-transmitting member against the pipeline. The reducer may be removably attached to the support member so that it may be interchanged with another reducer having a different inner diameter, thus adapting the apparatus for pipelines having different wall thicknesses. A hydraulic cylinder may actuate movement of the force-transmitting member.

### CROSS REFERENCE TO RELATED APPLICATIONS

This application claims the priority benefit of the filing date of U.S. Provisional Patent Application Ser. No. 63/280,947, filed Nov. 18, 2021, the entire contents of which are incorporated herein by reference.

### FIELD

The present invention relates to apparatuses and methods for loading a pig into a pipeline.

### BACKGROUND

A pig is a device that is run through a pipeline to clean, inspect, or perform other operations in respect to the pipeline. A pig may be made of a resilient material such as dense foam or polyurethane, or may include resilient disc or wiper elements. Considerable frictional forces between the pig and the interior of the pipeline may resist loading of the pig into the pipeline.

Various apparatuses for loading pigs or other devices into pipelines are known in the art. Nonetheless, there remains a need in the art for improvements in the art.

### SUMMARY OF THE EMBODIMENTS

The present invention relates to apparatuses and methods for loading a pig into a pipeline. It will be understood that the pipeline defines an axial forward direction from a pipeline end defining a pipeline opening into a pipeline interior, and a transverse direction perpendicular to the axial direction. It will be further understood that the pipeline comprises a cylindrical pipeline outer surface extending axially forward from the pipeline end, and a cylindrical inner pipeline inner surface extending axially forward from the pipeline end.

In a first aspect, the apparatus of the present invention comprises a support member, a tubular reducer, a force-transmitting member, a guide member, and at least one pipeline-engaging member. The support member is for engaging the cylindrical pipeline outer surface to support the apparatus on the pipeline. The reducer extends axially from a rear end to a front end configured for concentric alignment with and for bearing axially against the pipeline end, and has an inner diameter that decreases from the rear end to the front end. The force-transmitting member has a pig-engaging surface. The guide member is attached to the support member, and engages the force-transmitting member to limit transverse movement of the force-transmitting member relative to the reducer, while permitting the force transmitting member to move axially forward relative to the reducer such that the pig-engaging surface pushes the pig through the reducer into the pipeline interior. The at least one pipeline-engaging member is attached to the force-transmitting member so as to move in unison with the force-transmitting member relative to the reducer. The at least one pipeline-engaging member may comprise an outer pipeline-engaging member, or an inner pipeline-engaging member, or both outer and inner pipeline engaging members. The outer pipeline-engaging member is disposed to engage the pipeline outer surface. The inner pipeline-engaging member is disposed to engage the pipeline inner surface. The outer and/or inner pipeline-engaging member(s) (as may be present) move axially forward relative to the pipeline, when the force-transmitting member slides axially forward relative to the reducer and the front end of the reducer is bearing axially against the pipeline end. By virtue of the outer and/or inner pipeline-engaging member(s) engaging the pipeline, a portion of the attached force-transmitting member is braced against the pipeline. This may help to limit deformation of the force-transmitting member, and prevent undesired scraping of the force-transmitting member against the pipeline surfaces, which could damage coatings applied to them.

In embodiments, the pipeline-engaging member comprises the outer pipeline-engaging member comprising a rolling member rotatably attached to the force-transmitting member for rolling along the pipeline outer surface. In embodiments, the pipeline-engaging member comprises the inner pipeline-engaging member comprising a rolling member rotatably attached to the force-transmitting member for rolling along the pipeline inner surface. The rolling member(s) may comprise a wheel rotatably supported on an axle attached to the force-transmitting member.

In embodiments, the at least one pipeline-engaging member comprises the outer pipeline-engaging member comprising a first slide member attached to a portion of the force-transmitting member that is disposed transversely adjacent to the pipeline when the front end of the reducer is bearing axially against the pipeline end. In such embodiments, the first slide member is disposed to engage and slide axially forward on the pipeline outer surface, when the force-transmitting member slides axially forward relative to the reducer. embodiments, the first slide member comprises a convexly curved surface for engaging the pipeline outer surface. n embodiments, the first slide member comprises polytetrafluoroethylene.

In embodiments, the first slide member is removably attached to the force-transmitting member. In such embodiments, the first slide member may be attached to or form part of a sleeve member that slides onto a portion of the force-transmitting member. In such embodiments, the apparatus may further comprise a second slide member attached to or forming part of the sleeve member. The first slide member and the second slide member may be disposed on different portions of the sleeve member. The sleeve member may be selectively installed onto the portion of the force-transmitting member in both a first orientation and a second orientation. In the first orientation, the first slide member engages the pipeline outer surface but the second slide member does not engage the pipeline outer surface. In the second orientation, the second slide member engages the pipeline outer surface, but the first slide member does not engage the pipeline outer surface. In such embodiments, a transverse thickness of the first slide member may be different than a transverse thickness of the second slide member.

In respect to embodiments of the apparatus of the first aspect of the invention, the present invention also comprises a related method for loading the pig into the pipeline, such method comprising the steps of: (a) supporting the apparatus on the pipeline by engaging the support member with the cylindrical pipeline outer surface, with the front end of the tubular reducer abutting against the pipeline end; and (b) moving the force-transmitting member axially forward relative to the reducer such that the pig-engaging surface pushes the pig through the reducer and into the pipeline interior, while the at least one pipeline-engaging member moves in unison with the attached force-transmitting member and engages the pipeline inner surface or the pipeline outer surface to brace the attached force-transmitting member against the pipeline.

In a second aspect, the apparatus of the present invention comprises a support member, a first tubular reducer, a force-transmitting member, and a guide member. The support member is for engaging the cylindrical pipeline outer surface to support the apparatus on the pipeline. The first tubular reducer extends axially from a rear end to a front end configured for concentric alignment with and for bearing axially against the pipeline end, and has an inner diameter that decreases from the rear end to the front end. The first reducer is removably attached to the support member, so that it may be interchanged with another reducer having a different inner diameter, so that the apparatus can be adapted for pipelines having different wall thicknesses. The force-transmitting member has a pig-engaging surface. The guide member is attached to the support member, and engages the force-transmitting member to limit transverse movement of the force-transmitting member relative to the first reducer, while permitting the force-transmitting member to move axially forward relative to the reducer such that the pig-engaging surface pushes the pig through the first reducer and into the pipeline interior.

In embodiments, the front end of the first reducer defines an annular reducer flange that mates with a rear end of the support member when the reducer is attached to the support member. The support member may define an annular support member flange that mates with the reducer flange.

In embodiments, the support member comprises a tubular sleeve that fits circumferentially around the cylindrical pipeline outer surface.

In embodiments, the apparatus further comprises a second tubular reducer, like the first tubular reducer, except the inner diameter of the second reducer at the front end of the second reducer is different from the inner diameter of the first reducer at the front end of the first reducer.

In respect to embodiments of the apparatus of the second aspect of the invention, the present invention also comprises a related method for modifying the apparatus, such method comprising the steps of: (a) detaching the first tubular reducer from the support member; and (b) removably attaching the second tubular reducer to the support member. In embodiments, threaded bolts are used to removable attach the second reducer to the supper member. The method may be used to adapt the apparatus for use with pipelines of different wall thicknesses.

In a third aspect, the apparatus of the present invention comprises a support member, a tubular reducer, a force-transmitting member, a guide member, a hydraulic cylinder, and a cable. The support member is for engaging the cylindrical pipeline outer surface to support the apparatus on the pipeline. The reducer extends axially from a rear end to a front end configured for concentric alignment with and for bearing axially against the pipeline end, and has an inner diameter that decreases from the rear end to the front end. The force-transmitting member has a pig-engaging surface. The guide member is attached to the support member, and engages the force-transmitting member to limit transverse movement of the force-transmitting member relative to reducer, while permitting the force-transmitting member to move axially forward relative to the reducer such that the pig-engaging surface pushes the pig through the reducer into the pipeline interior. The hydraulic cylinder comprises a barrel securely attached to the force-transmitting member, and a piston rod movable relative to the barrel. The cable comprises a first end for attachment to the pipeline, and a second end attached to the piston rod. Between the first and second ends, the cable engages the force-transmitting member such that, when the first end is attached to the pipeline, tension in the cable induced by movement of the piston rod relative to the barrel actuates sliding of the force-transmitting member in the axially forward direction relative to the reducer.

In embodiments, the apparatus further comprises a sling for constricting around the pipeline. In use, the first end of the cable is attached to the pipeline via attachment to the sling.

In embodiments, the force-transmitting member comprises a sheave, and the cable engages the force-transmitting member via the sheave.

In embodiments, the force-transmitting member comprises a tubular portion, and either the barrel, or the piston rod, or both the barrel and the piston rod are contained in the tubular portion.

In respect to embodiments of the apparatus of the third aspect of the invention, the present invention also comprises a related method for loading a pig into a pipeline, such method comprising the steps of: (a) supporting the apparatus on the pipeline by engaging the support member with the cylindrical pipeline outer surface, with the front end of the tubular reducer abutting against the pipeline end; (b) securing the first end of the cable to the pipeline; and (c) using a pump to actuate the piston rod to move relative to the barrel of the hydraulic cylinder to induce tension in the cable, and thereby pull the force-transmitting member in the axially forward direction relative to the reducer such that the pig-engaging surface pushes the pig through the reducer and into the pipeline.

In embodiments, the apparatus may combine features of any two or more of the first, second and third aspects of the present invention, and the method may combine steps of two or more of the methods described in respect to the apparatuses of the first, second, and third aspects of the present invention. In the alternative to using a hydraulic cylinder and cable to move the force-transmitting member, as described for one embodiment above, the apparatus may further comprise a winch, and a cable comprising a first end wrapped around the winch, and a second end attached to the force-transmitting member, and these components may instead be used to move the force-transmitting member relative to the reducer.

In another aspect, there is provided a kit for loading a pig into a pipeline defining an axial forward direction from a pipeline end defining a pipeline opening into a pipeline interior, a transverse direction perpendicular to the axial direction, a cylindrical pipeline outer surface extending axially forward from the pipeline end, and comprising a cylindrical inner wall extending axially forward from the pipeline end, the apparatus comprising: (a) a support member for engaging the cylindrical pipeline outer surface to support the apparatus on the pipeline; (b) a plurality of removable and interchangeable tubular reducers, each extending axially from a rear end to a front end configured for concentric alignment with and for bearing axially against the pipeline end, and having an inner diameter that decreases from the rear end to the front end, wherein each reducer is removably attached to the support member, wherein each reducer has a different inner diameter at the front end; (c) a force-transmitting member with a pig-engaging surface; and (d) a guide member attached to the support member, wherein the guide member engages to the force-transmitting member to limit transverse movement of the force-transmitting member relative to the reducer, while permitting the force-transmitting member to move axially forward relative to the reducer such that the pig-engaging surface pushes the pig through the reducer and into the pipeline interior.

### BRIEF DESCRIPTION OF THE DRAWINGS

In the drawings, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. Throughout the drawings, dashed lines show parts that are hidden from view.

FIG. 1 is a side elevation view of an embodiment of an apparatus of the present invention for loading a pig into a pipeline, in relation to the pig and a portion of the pipeline.

FIG. 2 is a top view of the apparatus of FIG. 1, in relation to the pig and a portion of the pipeline.

FIG. 3 is a sectional view of the apparatus of FIG. 1, along line A-A of FIG. 1, in relation to the pig.

FIG. 4 is a side elevation view of a portion of the apparatus of FIG. 1, showing a rolling member attached to the plate of the force-transmitting member.

FIGS. 5A to 5C are side elevation views of embodiments of pin-type connections for releasably attaching parts of the apparatus. FIG. 5A shows threaded bolt and nut. FIG. 5B shows a dowel with a spring-biased ball bearing. FIG. 5C shows a dowel with a pin or clip.

FIG. 6 is an isometric view of the head of the pull rod of the apparatus of FIG. 1.

FIG. 7 is side elevation view of a portion of the apparatus of FIG. 1, showing a rolling member attached to the head of the pull rod, in relation to a portion of the pipeline.

FIG. 8 is a side elevation view of an embodiment of an apparatus of the present invention for loading a pig into a pipeline, in relation to a portion of the pipeline.

FIG. 9 is an isometric view of the sleeve member with attached slide member when disassembled from the head of the pull rod of the apparatus of FIG. 8.

FIG. 10 is side elevation view of a portion of the apparatus of FIG. 8, showing the sleeve member installed on the pull rod so that the thicker slide member engages the pipeline outer surface.

FIG. 11 is side elevation view of a portion of the apparatus of FIG. 8, showing the sleeve member installed on the pull rod so that the thinner slide member engages the pipeline outer surface.

FIG. 12 is a side elevation view of an embodiment of an apparatus of the present invention for loading a pig into a pipeline, in relation to a portion of the pipeline.

FIG. 13 is a side elevation view, along a vertical medial cross-sectional plane, of a portion of the apparatus of FIG. 12, showing the reducer detached from the support member.

FIG. 14 is a rear elevation view of the tubular reducer flange of the apparatus of FIG.

12.

FIG. 15 is a front elevation view of the support member flange of the apparatus of FIG. 12.

FIGS. 16A to 16C are side elevation views, along a vertical medial cross-sectional plane, of tubular reducers that may be provided as a kit with the apparatus of FIG. 12. FIG. 16A shows a first tubular reducer with the largest internal diameter. FIG. 16B shows a second tubular reducer with an intermediate internal diameter. FIG. 16C shows a third tubular reducer with the smallest internal diameter.

FIG. 17 is a side elevation view of another embodiment of an apparatus of the present invention for loading a pig into a pipeline, in relation to the pig and a portion of the pipeline.

FIG. 18 is a partial cut-away view of a portion of the apparatus of FIG. 17, shown at an enlarged scale.

### DETAILED DESCRIPTION OF EMBODIMENTS

### I. Definitions

Any term or expression not expressly defined herein shall have its commonly accepted definition understood by a person skilled in the art.

“Attached”, “attachment”, and like terms, as used herein, in describing the relationship between two parts includes the case where the two parts are directly attached to each other without an intervening part, and the case where the two parts are indirectly attached to each other with one or more intervening parts in between them.

“Cable”, as used herein, refers to any elongate member that can transmit a tensile force between its ends, and is sufficiently flexible to be wound around a curved object (such as a drum of a winch, or a section of a pipeline), irrespective of the constituent material of the cable. Non-limiting examples of cables include members commonly referred to as ropes, wire ropes, chains, straps, and belts.

“Pipeline inner surface”, as used herein, refers to the substantially cylindrical inner wall of a pipeline, which inner wall extends parallel to the elongate axial direction of the pipeline. “Pipeline outer surface”, as used herein, refers to the substantially cylindrical outer wall of a pipeline, which outer wall extends parallel to the elongate axial direction of the pipeline. The “pipeline inner surface” and the “pipeline outer surface” are distinct from the surface of a “pipeline end” that is transverse to the elongate axial direction of the pipeline.
“Winch”, as used herein, refers to any device that may be used to wind up and wind out a cable. In embodiments, a winch may be operated either manually, or using a powered mechanical device including, without limitation, an electrically-powered motor, or an internal combustion engine.

### II. General Overview of Exemplified Embodiments

Embodiments herein generally relate to an apparatus (10) for loading a pig (100) into a pipeline.

In some examples, the apparatus (10) includes at least one pipeline-engaging member attached to a force-transmitting member (30). The at least one pipeline-engaging member moves in unison with the force-transmitting member, relative to a reducer (20). The at least one pipeline-engaging member can include one or both of: (i) inner pipeline-engaging member(s); and (ii) outer pipeline-engaging member(s).

As provided herein, the inner and outer pipeline engaging-members are used to limit and mitigate deformation of the force-transmitting member (30) (e.g., owing to the weight of the force-transmitting member (30)). As explained herein, by reducing deformation, the apparatus minimizes friction between weighed-down/deformed components. This, in turn, allows components to slide freely relative to one another.

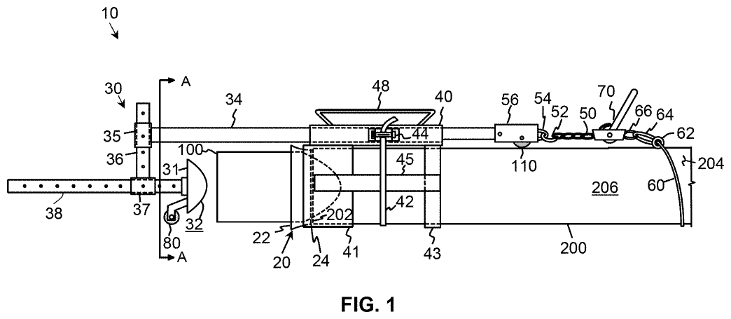

More generally, the inner pipeline-engaging member engages an inner pipeline surface. As exemplified, the inner pipeline-engaging member has one of a number of different design configurations. In at least one embodiment, the inner pipeline-engaging member is a rolling member (80) (see e.g., FIGS. 1, 3 and 4).

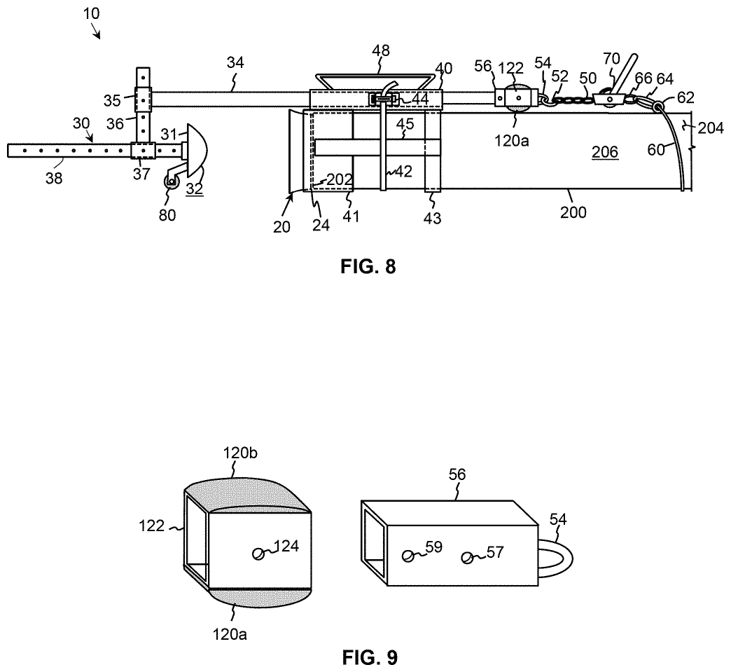

In contrast to the inner pipeline-engaging member, the outer pipeline-engaging member engages a pipeline outer surface (206). The outer member can also have one of a number of different design configurations. For example, the outer member can also comprise a rolling member (110), rotatably attached to the force-transmitting member (30) (FIGS. 1 and 7). In another example, the outer member comprises a slide member (120a or 120b) attached to the force-transmitting member (30) (FIG. 8).

In at least one embodiment, exemplified in FIGS. 13 to 16C, apparatus (10) is used with pipelines of different wall thicknesses, by removable attachment of a reducer (20) to a support member (41). Thus, one reducer (20) may be removed from the support member, and another reducer (20) having a different inner diameter may be attached to the support member, e.g., to adapt the apparatus to a pipeline (200) having a different diameter.

For example, the apparatus (10) may be provided with a kit, as shown in FIGS. 16A to 16C, of different reducers (20a; 20b; 20c) having different inner diameters, respectively. The reducers (20a, 20b, 20c) may be interchangeably attached to the support member (41).

More generally, the use of removable reducers can mitigate concerns of using multiple reducer extensions. For example, using multiple reducer extensions increases the number of parts in the apparatus. Further, the reducer extensions effectively increase the axial length of the reducer through which the pig must be inserted. As well, any mismatch between the inner surface of the reducer extension and the inner surface of the reducer may interfere with smooth passage of the pig.

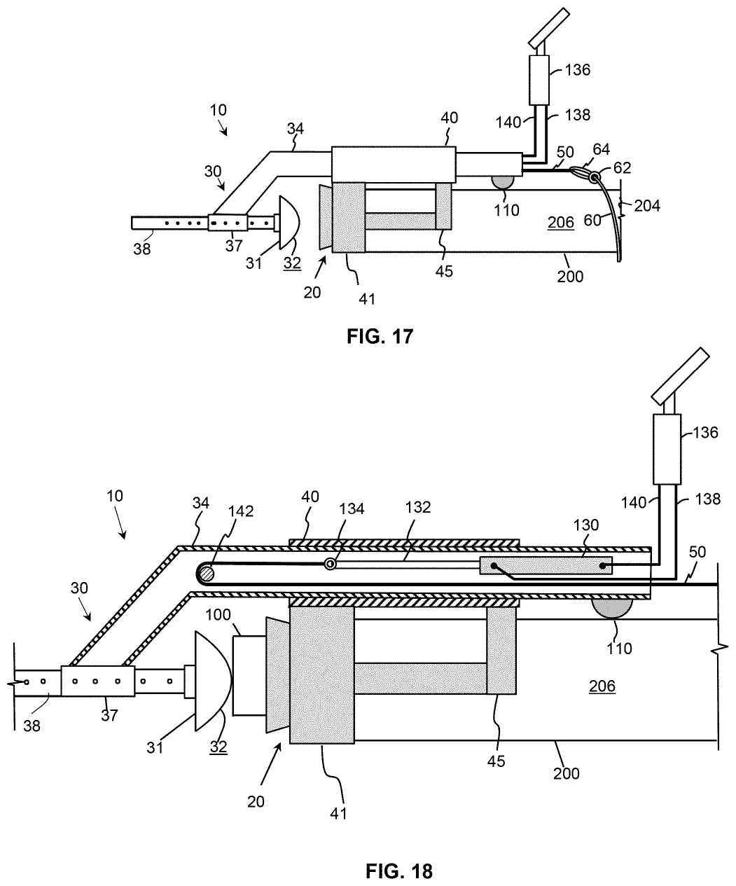

In at least one embodiment, which is exemplified best in FIGS. 17 to 18, the tensioning mechanism includes a hydraulic cylinder (130, 132), and a manually-powered hydraulic pump (136). The hydraulic cylinder is used to actuate movement of the force-transmitting member (30).

Use of a hand pump may advantageously avoid the need for a power supply. Further, the use of a hand pump may be more convenient than using other tensioning mechanisms (e.g., winches), which can require a lot of force to operate, especially for large pig sizes. In particular, as the size of the pig increases, so too does the amount of friction resisting passage of the pig through the reducer and into the pipeline, and the amount of force required to operate the tensioning mechanisms (e.g., a lever of a winch).

An apparatus (10) can be designed with any combination, or sub-combination, of the above-noted features. For example, an apparatus (10) can have any combination, or sub-combination, of: (i) at least one pipeline-engaging member (e.g., one or both of the inner and outer pipeline-engaging member(s)) (FIGS. 1 to 7); (ii) a removable attachment of the reducer (20) to a support member (41) and associated kit (FIGS. 13 to 16C); and/or (iii) a tensioning mechanism including a hydraulic cylinder and pump (FIGS. 17 — 18).

III. General Description of Apparatus

The following is a general discussion which provides a basis for understanding several of the features which are discussed herein. As discussed in detail subsequently, each of the features may be used by themselves in an apparatus, or in combination with one or more of the other features.

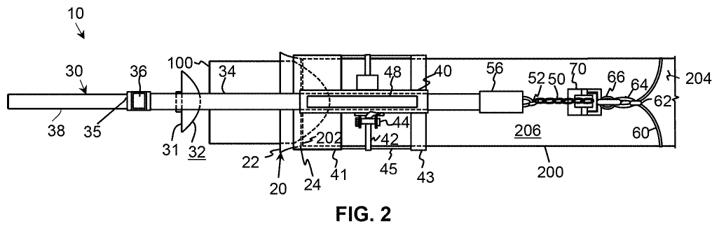

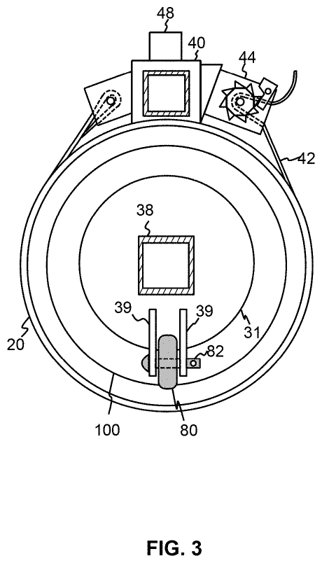

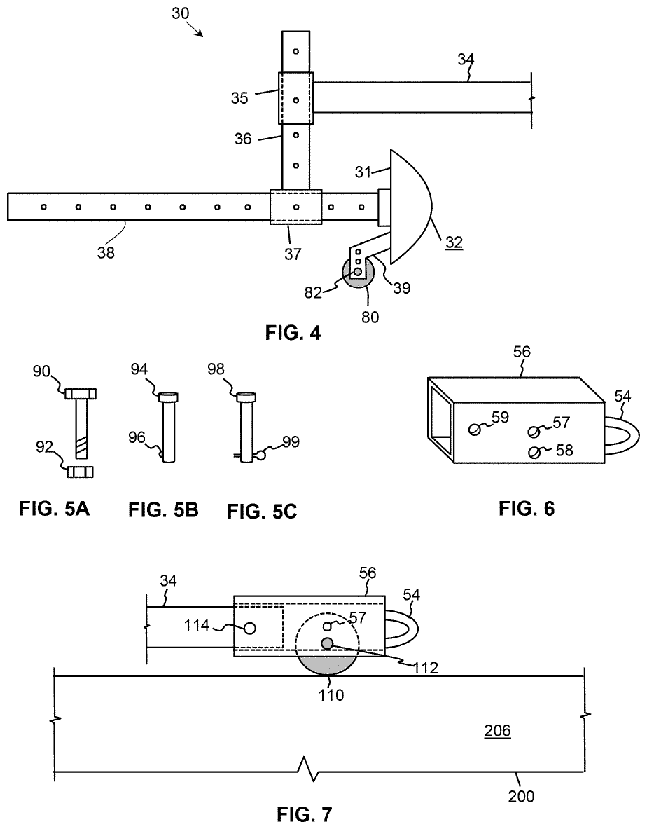

FIGS. 1 and 2 show a side view and a top view, respectively, of an example embodiment of an apparatus (10) of the present invention for loading a pig (100) into a pipeline (200), when mounted on the pipeline (200). FIG. 3 shows a cross-sectional view of this embodiment along section line A-A of FIG. 1. FIGS. 4 to 7 show portions or parts of this embodiment.

Referring to FIG. 1, pipeline (200) defines an axial forward direction from a pipeline end (202) defining a pipeline opening into a pipeline interior (204), and a transverse direction perpendicular to the axial direction. In FIG. 1, the axial forward direction corresponds to the direction from left to right in the drawing plane, and the transverse direction includes the direction from bottom to top in the drawing plane, and the direction perpendicular to the drawing plane. As an illustrative example, the pipeline (200) may have an outer diameter of approximately 12 inches (30 cm), and the pig (100) may be made of foam and bullet-shaped.

The present invention is not limited by the size of the pipeline (200), or the material or shape of the pig (100).

In this embodiment, the apparatus (10) includes a tubular reducer (20), a force-transmitting member (30), a guide member (40), at least one support member (41), a tensioning mechanism, and other parts, as described below. These parts of the apparatus (10) may be made of any suitably strong and rigid material, with non-limiting examples including metals such as steel or aluminum, plastic, or a composite material.

Tubular reducer.

The tubular reducer (20) facilitates insertion of the pig (100) into pipeline end (202). The reducer (20) extends axially from a rear end (22) to a front end (24). The reducer (20) has an inner diameter that is sized to permit passage of the pig (100), and decreases from the rear end (22) to the front end (24) to compress the pig (100) as it moves axially forward through the reducer (20) and toward the pipeline end (202). The reducer (20) is sized such that the front end (24) can be concentrically aligned with the pipeline end (202), so that the reducer (20) and pipeline opening collectively form a passage for the pig (100). In use, the front end (24) of the tubular reducer (20) bears, directly or indirectly, against the pipeline end (202) to transmit axial force to the pipeline end (202), when loading the pig (100) into the pipeline and thereby limit axial movement of the apparatus (10) relative to the pipeline (100).

In at least one embodiment, the inner wall of the reducer (20) is substantially bell-shaped or conical-shaped, such that the inner diameter of the reducer (20) gradually tapers from the rear end (22) to the front end (24), so as to gradually compress the foam pig (100) in the transverse direction as it moves axially forward through the reducer (20). The front end (24) of the reducer (20) has an annular surface in a transverse plane that bears directly against the annular surface of the pipeline end (202).

Force-transmitting member and pig-engaging surface.

The force-transmitting member (30) has an attached to a pig-engaging surface (32). In this embodiment, the force-transmitting member (30) transmits a force from the first cable (50) to the pig-engaging surface (32), such that the pig-engaging surface (32) pushes the pig (100) through the passage defined by the reducer (20) and the pipeline opening into the pipeline interior (204).

In this example embodiment, the force-transmitting member (30) is formed by a circular plate (31), a pull rod (34), an intermediate rod (36), and a plunger rod (38). The plate (31) is fixedly attached to the front end of the plunger rod (38), such as by fasteners such as bolts, or by welding. The axially forward facing surface of the plate (31) forms the pig-engaging surface (32). The plate (31) is preferably sufficiently large so that the pig-engaging surface distributes a compressive force fairly evenly across a rear-facing surface of the pig (100).

In this embodiment, the pig-engaging surface (32) is convexly-shaped, so as to be complementary in shape to a concavely-shaped rear end of the pig (100). The complementary shape of the pig-engaging surface (32) and the rear end of the pig (100) may help transversely centralize the pig-engaging surface (32) in respect to the pig (100). For this purpose, the pig-engaging surface (32) may define an aperture at its center that receives a bolt or other protuberance extending axially from the rear end of the pig (100), as may be found on some pigs (not shown). In other embodiments, the pig-engaging surface (32) may be flat or have different contours.

In this embodiment, the plate (31) is secured with bolts to the plunger rod (38), so that it may be detached from each other, and re-attached in a reverse orientation so that a concavely-shaped side of the plate (31) is positioned opposite to the tapered end of the bullet-shaped pig (100) in a reverse orientation with its tapered end pointing away from the pipe line end (202) in the axial rearward direction. When the plate (31) is in this reverse orientation, the apparatus (10) may be used to load the pig (100) in the reverse orientation.

In this embodiment, each of the pull rod (34), intermediate rod (36), and plunger rod (38) are made of a steel tubular member having a hollow square cross-section with external dimensions of approximately 2-¹/₂ inches per side. In other embodiments, the tubular members may be cylindrical, and/or have smaller or larger dimensions depending on factors such as the size of the pig (100), the anticipated amount of friction that has to be overcome to load the pig (100) into the pipeline (200), and the material properties of the member.

In this embodiment, the axial and transverse position of the pig-engaging surface (32) relative to the pipeline end (202) are adjustable, when the apparatus (10) is mounted on the pipeline end (202). The axial adjustability accommodates pigs (100) of different axial lengths, while the transverse adjustability accommodate pigs (100) and pipelines (200) of different diameters. In general, the axial and transversely adjustability may be implemented by forming the force-transmitting member (30) from a first portion, and a second portion that is attached to the pig-engaging surface (32) and is movably attached to the first portion.

In this embodiment, the transverse adjustability is achieved by a transversely-extending collar (35) welded to the rear end of the pull rod (34). The transversely-extending collar (35) is a steel tubular member having a hollow square cross-section with an inner dimension slightly larger than the outer dimension of the intermediate rod (36). By transverse sliding of the intermediate rod (36) within the transversely-extending collar (35), one of several transversely spaced-apart apertures defined by the intermediate rod (36) can be selectively aligned with an aperture defined by the transversely-extending collar (35). A pin-like fastener (e.g., a bolt, or dowel) can be inserted through the aligned apertures to secure the transverse position of intermediate rod (36) relative to the pull rod (34), and hence fix the transverse position of the pig-engaging surface (32), relative to the pipeline end (202).

In this embodiment, the axial adjustability is achieved by an axially-extending collar (37) welded to the bottom end of the intermediate rod (36). The axially-extending collar (37) is a steel tubular member having a hollow square cross-section with an inner dimension slightly larger than the outer dimension of the plunger rod (38). By axial sliding of the plunger rod (38) within the axially-extending collar (37), one of several axially spaced-apart apertures defined by the plunger rod (38) can be selectively aligned with an aperture defined by the axially-extending collar (37). A pin-like fastener (e.g., a bolt, or dowel) can be inserted through the aligned apertures to secure the axial position of plunger rod (38) relative to the intermediate rod (36), and hence fix the axial position of the pig-engaging surface (32), relative to the pipeline end (202), for a given position of the pull rod (34).

Guide member.

The guide member (40) slidably receives the force-transmitting member (30) while constraining movement of the force-transmitting member (30) and the attached pig-engaging surface (32) relative to the pipeline opening in the axial direction when the apparatus (10) is mounted on the pipeline (200).

In this exemplified embodiment, the guide member (40) is made of an axially-extending steel tubular member having a hollow square cross-section in a transverse plane, with an inner dimension slightly larger than the outer dimension of the pull rod (34), so as to receive and permit axial sliding of the pull rod (34) therein, while substantially preventing transverse movement of the pull rod (34) therein.

In other embodiments, the guide member (40) may be cylindrical, and/or may or may not be tubular, so long as the guide member (30) is configured to permit sliding axial movement, while substantially preventing relative transverse movement of the pull rod (34), relative to the guide member. For example, the guide member (40) may comprise one or members having a C-shaped cross-section in a transverse plane, that define a channel or track for sliding of the pull rod (34).

Handle.

In this example embodiment, an inverted U-shaped handle (48) is attached to the upper surface of the guide member (40). The handle (48) may be used when positioning the subassembly on the pipeline (200). In other example embodiments, any other suitable design or configuration of the handle can be used. In still other examples, it is not necessary to include a handle in the apparatus.

Support member.

The apparatus (10) may include one or more support members for supporting the apparatus (10) by engaging a cylindrical pipeline outer surface (206) to facilitate positioning the front end (24) of the reducer (20) into concentric alignment, and direct or indirect axially bearing relationship, with the pipeline end (202). By virtue of its engagement with the pipeline outer surface (206) and its rigid attachment to the guide member (40), the support member also helps to ensure that the elongate axis of the guide member (40) is substantially aligned with the axial direction of the pipeline (200), so that movement of the force-transmitting member (30) and its pig-engaging surface (32) relative to the reducer (20) is substantially limited to the axial direction. This avoids or minimizes application of forces to the pig (100) that are misaligned with the axial direction, which can damage the pig (100) or be counterproductive to pushing the pig (100) into the pipeline (200).

In this example embodiment, for example, the support members include a rear tubular sleeve (41) and a front tubular sleeve (43) attached by an axially extending member (45). In this embodiment, the rear tubular sleeve (41) and the front tubular sleeve (43) have an inner diameter slightly larger than the outer diameter of the pipeline (200), so that they can slide loosely over the pipeline end (202), until the front end (24) of the tubular reducer (20) abuts the pipeline end (202).

In this example embodiment, the outer surface of the rear tubular sleeve (41) and the outer surface of the front tubular sleeve (43) are welded to the guide member (40). Further, the inner surface of the rear portion of the rear tubular sleeve (41) is welded to the outer surface of the tubular reducer (20). As such, the reducer (20) is attached to the guide member (40) via the tubular sleeve (41), so that these parts collectively for a single rigid unit. In this manner, it will be appreciated that the force-transmitting member (30) can be considered as being slidably attached to the reducer (20), the guide member (40), and the tubular sleeve (41) of the support member.

In other embodiments, the rear tubular sleeve (41) or the front tubular sleeve (43) may be modified as an arcuate member that extends circumferentially only partially around the pipeline (200), so as to sit like a saddle on the pipeline outer surface (206).

Fastening mechanism for guide member.

A fastening mechanism may be provided to releasably secure the guide member (40) to the pipeline end (202) before inducing tension in the first cable (50).

In at least one embodiment, the releasable fastening mechanism includes a cable in the form of a nylon strap (42) and a manually operable ratcheting winch (44) that tightens the strap (42) circumferentially around the pipeline (200). Referring to FIG. 3, one end of the strap (42) forms a loop around an axially extending pin attached to the left side of the guide member (40). The strap (42) wraps circumferentially around the pipeline (200). The free end of the strap (42) passes through the ratcheting winch (44). The ratcheting winch (44) is used to tighten the strap (42) circumferentially around the pipeline (200), and thereby resist movement of the guide member (40) relative to the pipeline (200). Although this embodiment of the apparatus (10) has one strap (42), it may be desirable to provide two or more straps (42), particularly for pipelines having diameters of 16 inches (406 mm) or greater.

In other embodiments (not shown), the support member may be modified as described and shown in FIG. 3 of US 11,156,321 to Peterson, the entire contents of which are incorporated herein by reference, where permitted. In such embodiments, the support member includes an arcuate band that fits circumferentially around the pipeline outer surface. The guide member (40) is attached to the arcuate band. A threaded bolt in cooperation with threaded retainers attached to opposite ends of the arcuate band are used to draw the ends of band together to clamp the arcuate band against the pipeline outer surface (206). Friction between the inner surface of the band and the pipeline outer surface (206) resists movement of the guide member (40) relative to the pipeline (200).

### IV. Example Tensioning Mechanisms

The following is a description of tensioning mechanisms which can be used in any combination, or sub-combination, with any other aspect(s) or feature(s) described herein with respect to the apparatus (10).

Any design or configuration for a tensioning mechanism can be used in the apparatus (10). In exemplified embodiments, the tensioning mechanism includes: (i) a cable-based mechanism (see e.g., FIGS. 1 to 16), and/or (ii) a hydraulic-based mechanism (See e.g., FIGS. 17 and 18).

### (A) EXAMPLE #1

### Cable-Based Tensioning Mechanism

In at least one embodiment, the tensioning mechanism includes a cable-based mechanism comprising the first cable (50), the winch (70), and the second cable (60).

Tensioning mechanism: first cable.

In this exemplified embodiment, the first cable (50) is attached to the pull rod (34) so that tension induced in the first cable (50) pulls the pull rod (34) and its attached pig-engaging surface (32) in the axially forward direction toward the pipeline end (202). The pull rod (34) may be configured for attachment to the first cable (50) in any suitable manner so that the first cable (50) can transmit tensile force to the force-transmitting member (30). In this embodiment, for example, the first cable (50) is in the form of a steel chain made of numerous connected links. The rear end of the first cable (50) is attached a loading hook, loop, eyelet or pin (54) attached to the head (56) of the pull rod (34). The loading hook, loop, eyelet or pin (54) is preferably configured so that the force imparted by the hook (52) is substantially aligned with the axial direction. It may be desirable to minimize the transverse component of the force on the pull rod (34), as it tends to bend the pull rod (34) downward and increase friction between the pull rod (34) and the inner wall of the guide member (40), both of which may interfere with the pull rod (34) sliding freely within the guide member (40). In other embodiments, the force-transmitting member (30) may be configured for attachment to the first cable (50) by defining an aperture for securing the first cable (50), or by including an attached fastener such as a shackle, a hook, a clamp, a clip, a hitch, or an anchor, for securing the first cable (50).

Tensioning mechanism: second cable.

In the exemplified embodiment, the second cable (60) is used to secure the winch (70) to the pipeline (200), by forming a sling that loops circumferentially around the pipeline (200) and constricts around the pipeline (200). The winch (70) is configured for attachment to the second cable (60) in any suitable manner so that tension in the first cable (50) is transmitted via the winch (70) to the second cable (60) so that the sling tightens around (i.e., chokes) the pipeline (200) to restrain the winch (70) against movement relative to the pipeline (200). In this embodiment, for example, the second cable (60) is in the form of a 2-inch wide nylon strap that wraps around the pipeline (200) to form a sling. A first end of the second cable (60) is attached to an eyelet (62). The opposite second end of the second cable (60) is threaded through the eyelet (62), and forms an end loop (64) that engages a shackle (66) attached to the front end of the winch (70). In other embodiments, the winch (70) may configured for attachment to the second cable (60) by defining an aperture for securing the second cable (60), or by including an attached fastener such as a hook, a clamp, a clip, a hitch, or an anchor for securing the second cable (60).

Tensioning mechanism: winch.

The rear end of the first cable (50) is wound around the drum of the winch (70). In use, rotating the drum of the winch will tend to draw in the first cable (50), and thereby pull the force-transmitting member (30) in the axially forward direction. In this embodiment, the winch (70) is a manually operable ratcheting come-a-long winch (70) (also known as a come-a-long cable puller) that is used to wind the first cable (50). As known in the art, a typical ratcheting come-along winch (70) includes a drum for winding the cable, and an associated toothed-wheel rotatably mounted on a frame. A lever with an attached pawl is pivotally attached to the frame. Pivoting of the lever relative to the frame in one direction causes the pawl to catch the toothed-wheel, thereby rotating the drum in one direction, while preventing rotation of the drum in the opposite direction.

Tensioning mechanism with cables: alternatives.

In other embodiments, the second cable (60) may be omitted. Instead of attaching the winch (70) to the pipeline (60) with second cable (60), the winch (70) may be secured to another object such as a vehicle or a structure in the vicinity of the pipeline (200).

In still other embodiments, the winch (70) and the second cable (60) may be omitted. Instead, another machine such as a vehicle may be attached to the first cable (50) directly, and used to induce tension in the first cable (50).

In still other embodiments, one or more of the first cable (50), second cable (60) and winch (70) may be omitted. Instead, movement of the force-transmitting member (30) relative to the guide member (40) may be effected by some other machine applying either a tensile or a compressive force to the force-transmitting member (30). In this regard, reference is made to the embodiment of the apparatus (10) shown in FIGS. 17 and 18, as described below.

### (B) EXAMPLE #2

### Hydraulic-Based Tensioning Mechanism

FIGS. 17 and 18 show another example embodiment for a hydraulic-based tensioning mechanism.

More generally, FIG. 17 shows another embodiment of an apparatus (10) of the present invention. FIG. 18 shows a portion of the apparatus (10) at an enlarged scale, with the pull rod (34) and guide member (40) being shown along a medial cross-section to reveal internal components within.

In this embodiment, the support member replaces the rear tubular sleeve (43) with an arcuate member (45) that sits like a saddle on the pipeline outer surface (206).

In this embodiment, the tensioning mechanism includes a cable (50), a hydraulic cylinder (130, 132), and a hydraulic pump (136).

The hydraulic cylinder is conventional, and includes a barrel (130) and a piston rod (132) that moves linearly relative to the barrel (130) in response to changes in pressure of hydraulic fluid in the barrel (130). Such changes in pressure are effected by the hydraulic pump (136) in fluid communication with the barrel (130) via hydraulic lines (138, 140). In embodiments, the hydraulic pump (136) may be a manually powered hand pump, or an electrically powered or pneumatically powered motor pump. Use of a manually powered hand pump may advantageously avoid the need for a power supply. Although FIGS. 17 and 18 show the pump (136) above the pipeline (200), it will be appreciated that in practice, the hydraulic pump (136) may be placed on the ground adjacent to the pipeline (200) or upon some other structure or base.

The barrel (130) is securely attached to the force-transmitting member (30) so that the piston rod (132) moves relative to the force-transmitting member (30) when it moves relative to the barrel (130). In this embodiment, the barrel (130) may be securely attached to the pull rod (34) of the force-transmitting member (30) by use of fasteners such as bolts and nuts, screws, clips, clamps, or the like that allow the barrel (130) to be detached from the pull rod (34). In other embodiments, the barrel (130) may be secured to the pull rod (34) or other parts of the force-transmitting member (30) by other means, such as by welding.

In this embodiment, as shown in FIG. 18, the barrel (130) and the piston rod (132) are contained inside the tubular pull rod (34), which is formed from welded tubular members of rectangular cross-section. The barrel (130) is attached to the inner wall of the pull rod (34), but the piston rod (132) is free to move linearly relative to the barrel (130) and the pull rod (34). Placing the barrel (130) and the piston rod (132) inside the tubular pull rod (34) may advantageously protect them from environmental elements, and prevent damage to them from impacts during handling and transportation of the apparatus (10).

In use, a first end of the cable (50) is attached, directly or indirectly, to the pipeline (200) to transmit a tensile force to the pipeline (200). In the embodiment shown in FIG. 17, the first end of the cable (50) is attached to the end loop (64) of a second cable (60) that forms a sling around the pipeline (200) as was described above in respect to the embodiment of the apparatus (10). In other embodiments, the first end of the cable (50) may be attached, directly or indirectly, to the pipeline (200) by other means such that the cable (50) can transmit tension in the cable (50) to the pipeline (200).

A second end of the cable (50) of the cable is secured to the piston rod (132) to transmit a tensile force to the piston rod (132). In this embodiment, the end of the piston rod (132) has an attached eyelet (134) to which the second end of the cable (50) is tied. In other embodiments, the second end of the cable (50) may be secured to the piston rod (132) by other means. As a non-limiting example, the cable (50) may be looped through an aperture defined by the piston rod (132), or engage a hook attached to the piston rod (132).

Between its first and second ends, the cable (50) engages the force-transmitting member (30) such that tension in the cable pulls the force-transmitting member (30) in the axial forward direction. In this embodiment, a sheave (142) (i.e., a disc-shaped member having a groove along its circumference to receive the cable (50)) is securely attached to the inner wall of the tubular pull rod (34). The cable (50) wraps around the axial rearward side of the sheave (142) so that tension in the cable (50) applies an axial forward force to the sheave (142) and hence, also to the pull rod (34) attached thereto. In other embodiments, the cable (50) may engage the pull rod (34) or other parts of the force-transmitting member (30) to achieve this effect.

The use and operation of this embodiment of the apparatus (10) is similar to the use and operation of the embodiments of the apparatus (10) described above, except that the hydraulic cylinder is used to actuate movement of the force-transmitting member (30). With the apparatus set up as shown in FIG. 18, the operator uses the pump (136) to retract the piston rod (132) into the barrel (130). This increases tension in the cable (50) because the first end of the cable (50) is secured to the pipeline (200) via the sling formed by the second cable (60). Increased tension in the cable (50) is transmitted as an axial forward force to the pull rod (34) via sheave (142). This causes the pull rod (34) to move in the axial forward direction, whereupon the attached pig-engaging surface (32) pushes the pig (100) through the reducer (20) and into the pipeline (100).

The embodiment of the apparatus (10) shown in FIG. 18 may be modified by reversing the orientation of the barrel (130) and piston rod (132) such that the piston rod (132) is axially forward of the barrel (130). In such embodiment, extension (rather than retraction) of the piston rod (132) from the barrel (130) in the axial forward direction would be used to pull the pull rod (34) in the axial forward direction.

### V. Example Pipeline-Engagement Member(s)

The following is a description of pipeline-engagement member(s) which can be used in any combination, or sub-combination, with any other aspect(s) or feature(s) described herein with respect to the apparatus (10).

As provided, the apparatus (10) can include one or more pipeline-engagement members. These can include one or both of: (i) inner pipeline-engagement member(s), and (ii) outer pipeline engagement member(s).

Any number of inner and/or outer pipeline-engagement members can be provided in the apparatus (10).

### (a) Inner Pipeline-Engagement Member(s)

The following is a description of various example design configurations for inner pipeline-engagement member(s).

Rolling member for contacting the pipeline inner surface.

Referring to FIGS. 1, 3, and 4, this exemplified embodiment of the apparatus (10) includes a rolling member (80) rotatably attached to the force-transmitting member (30), and positioned for rolling axially along the pipeline inner surface, as the force-transmitting member (30) moves axially relative to the pipeline (200). Thus, the rolling member (80) moves in unison with the force-transmitting member (30) relative to the reducer (20). The rolling member (80) may be considered as an “inner pipeline-engaging member”. Accordingly, by virtue of the rolling member (80) engaging the pipeline inner surface, the plunger rod (38) of the force-transmitting member (30) is braced against the pipeline inner surface, while still being able to move axially relative to the pipeline (200). This helps to limit deformation of the force-transmitting member (30).

In this embodiment, referring to FIG. 4, the rolling member (80) is in the form of a wheel rotatably attached by an axle (82) inserted through aligned apertures defined by the wheel (80) and a pair of brackets (39) extending from the plate (31) of the force-transmitting member (30). The wheel (80) may be made of a variety of materials, with non-limiting examples including metal, rubber, or polyurethane. It may be preferable for the material to have a sufficiently high elastic modulus to prevent the rolling member (80) from being compressed to any appreciable degree, which would be counter-productive to its intended effect. The brackets (39) define a plurality of apertures at different vertical positions. The aperture of the wheel (80) may be selectively aligned with one of these apertures, so that the wheel (80) can be selectively positioned at different heights relative to the force-transmitting member (30). Alternatively, different sized wheels can be attached to the brackets (39). In these ways, the wheel (80) can be positioned or sized to accommodate pipelines (200) having different inner diameters.

In this embodiment, the axle (82) may be removable from the brackets (39) to facilitate installation and removal of the wheel (80). FIGS. 5A-5C show pin connections that can be used as non-limiting implementations of the axle (82). In one example, as shown in FIG. 5A, the axle (82) may implemented by a threaded bolt (90), and secured to the bracket with a threaded nut (92). In another example, as shown in FIG. 5B, the axle (82) may implemented by what is known in the art as a quick-release pin or dowel. This includes a dowel (94), a bearing (96), and an internal spring (not shown) that biases the ball bearing (96) outwardly to interfere with the bracket (39), until the dowel (94) is pulled with sufficient force that the bracket (39) depresses the ball bearing (96) sufficiently into the dowel (94) to allow the dowel (94) to be pulled through the apertures. In still another example, as shown in FIG. 5C, the axle (82) may implemented by a dowel (98) defining an aperture for removable insertion of a pin or clip (99), such as a split pin, cotter pin, or R-clip.

In other embodiments (not shown), the rolling member (80) may take other forms and/or be rotatably attached to the force-transmitting member (30) by other means. For example, the rolling member (80) may be a ball bearing rotatably attached to the force-transmitting member (30) by a socket attached to the force-transmitting member (30). In any case, it may be preferable for the rotatable attachment means to be configured to limit rotation of the rolling member (80) to the axial direction.

### (b) Outer Pipeline-Engagement Member(s)

The following is a discussion of various example design configurations for outer pipeline-engagement member(s).

Example #1: Rolling member for contacting the pipeline outer surface.

Referring to FIGS. 1, 6 and 7, this exemplified embodiment of the apparatus (10) includes another rolling member (110) rotatably attached to the force-transmitting member (30), and positioned for rolling along the pipeline outer surface (206) as the force-transmitting member (30), moves axially relative to the pipeline (200). Thus, the rolling member (110) moves in unison with the force-transmitting member (30) relative to the reducer (20). The rolling member (110) may also be considered as an “outer pipeline-engaging member”. Accordingly, by virtue of the rolling member (110) engaging the pipeline outer surface (206), the pull rod (34) of the force-transmitting member (30) is braced against the pipeline outer surface (206), while still being able to move axially relative to the pipeline (200). This helps to limit deformation of the force-transmitting member (30).

In this embodiment, referring to FIG. 7, the rolling member (110) is in the form of a wheel, rotatably attached by an axle (112) inserted through an apertures defined by the wheel (110) aligned with an aperture (57, or 58) defined by the head (56) of the pull rod (34). The wheel (110) may be made of a variety of materials, with non-limiting examples including metal, rubber, or polyurethane. It may be preferable for the material to have a sufficiently high elastic modulus to prevent the wheel (110) from being compressed to any appreciable degree, which would be counter-productive to its intended effect. The head (56) of the pull rod (34) defines a pair of apertures (57, 58) at different vertical positions. The aperture of the wheel (110) may be selectively aligned with one of these apertures (57, 58) so that the wheel (110) can be selectively positioned at different heights relative to the pull rod (34). Alternatively, different sized wheels can be attached to the head (56). In these ways, the wheel (110) can be positioned or sized to accommodate pipelines (200) having different outer diameters.

In this embodiment, the axle (112) may be removable from the head (56) to facilitate installation and removal of the wheel (110). FIGS. 5A-5C, as previously described, show pin connections that can be used as non-limiting implementations of the axle (112).

In this embodiment, the head (56) of the pull rod (34) is itself removably attached to the pull rod (34). The head (56) is a steel tubular member having a hollow square cross-section sized with an inner dimension slightly larger than the outer dimension of the pull rod (34) so as to be slidable, in a sleeve-like manner, over the front of the pull rod (34) within close tolerance. The head (56) defines an aperture (59) that can be aligned with an aperture defined by the pull rod (34). The head (56) and pull rod (34) may be removably attached by insertion of a pin connection (114) through the aligned apertures. FIGS. 5A-5C, as previously described, show pin connections that can be used as non-limiting implementations of the pin connection (114). In other embodiments, the head (56) of the pull rod (34) may be permanently attached to or be part of the pull rod (34).

In other embodiments (not shown), the rolling member (110) may take other forms and be rotatably attached to the force-transmitting member (30) by other means. For example, the rolling member (110) may be a ball bearing, rotatably attached to the force-transmitting member (30) by a socket attached to the force-transmitting member (30). In any case, it may be preferable for the rotatable attachment means to be configured to limit rotation of the rolling member (110) to the axial direction.

Example #2: Slide member attached to force-transmitting member for contact with pipeline outer surface.

FIG. 8 shows a side view of anembodiment of an apparatus (10) of the present invention for loading a pig (100) into a pipeline (200), when mounted on the pipeline (200). The pig (100) is omitted for clarity, but in use, would be positioned in a manner analogous to that shown in FIG. 1. FIGS. 9 to 11 show portions or parts of this embodiment. This embodiment is similar to the embodiment shown in FIG. 1, with certain differences described below.

One embodiment of the apparatus (10) includes a slide member (120a, or 120b) attached to the force-transmitting member (30) and positioned for sliding against the pipeline outer surface (206) as the force-transmitting member (30) moves axially relative to the pipeline (200). Thus, the slide member (120a, or 120b) moves in unison with the force-transmitting member (30) relative to the reducer (20). The slide member (120a, or 120b) may also be considered as an “outer pipeline-engaging member”. Accordingly, by virtue of the slide member (120a, or 120b) engaging the pipeline outer surface, the force-transmitting member (30) is braced against the pipeline (200), while still being able to move axially relative to the pipeline (200). This helps to limit deformation of the force-transmitting member (30).

The slide member (120a, or 120b) may be made of a variety of different materials, but it will be appreciated that it may be desirable for the material to be relatively wear resistant and have a low coefficient of friction. As non-limiting examples, the slide member (120a, or 120b) may be made of polished steel or other metal, a plastic, a polytetrafluoroethylene composition (e.g., Teflon™), or a polyurethane. It may be preferable for the material to have a sufficiently high elastic modulus to prevent the slide member (120a, or 120b) from being compressed to any appreciable degree, which would be counter-productive to the intended effect. The two slide members (120a, or 120b) may be made of the same material or different material, to accommodate different types of materials forming the pipeline outer surface (206) or to produce different amounts of friction with the pipeline outer surface (206). For instance, the first and second slide members (120a and 120b) may be made of different types of the aforementioned materials (metal, a plastic, a polytetrafluoroethylene composition (e.g., Teflon™), or a polyurethane), or of materials of the same type but having different mechanical properties (e.g., hardness, or coefficient of friction).

In this exemplified embodiment, the outer surface of the slide member (120a, or 120b) is convexly curved. In comparison with a relatively flat outer surface, the convex curvature reduces the amount of surface area of the slide member (120a, or 120b) that contacts the pipeline outer surface (120a, or 120b) so as to reduce resistance to sliding of the slide member (120a, or 120b) on the pipeline outer surface (206).

In this embodiment, referring to FIG. 9, the slide member (120a, or 120b) is removably attached to the head (56) of the pull rod (34) by a sleeve member (122). This facilitates replacement of the slide member (120a, or 120b) if they are worn, and or selection of one of the two slide members (120a, or 120b) for contacting the pipeline outer surface (206). The sleeve member (122) is a tubular member having a hollow square cross-section sized with an inner dimension slightly larger than the outer dimension of the head (56) of pull rod (34) so as to be slidable over the head (56) of the pull rod (34) within close tolerance. The sleeve member (122) may be made of a variety of materials, with non-limiting examples including steel or other metal, a plastic, a polytetrafluoroethylene composition (e.g., Teflon™), or a polyurethane. The sleeve member (122) and the slide member (120a, or 120b) may be made of the same material, in which case they may be formed monolithically with each other, or formed separately and attached to each other, such as by bonding, or with fasteners. Alternatively, the sleeve member (122) and the slide member (120a, or 120b) may be made of different materials, in which case they may be formed separately and attached to each other, such as by bonding, or use of fasteners.

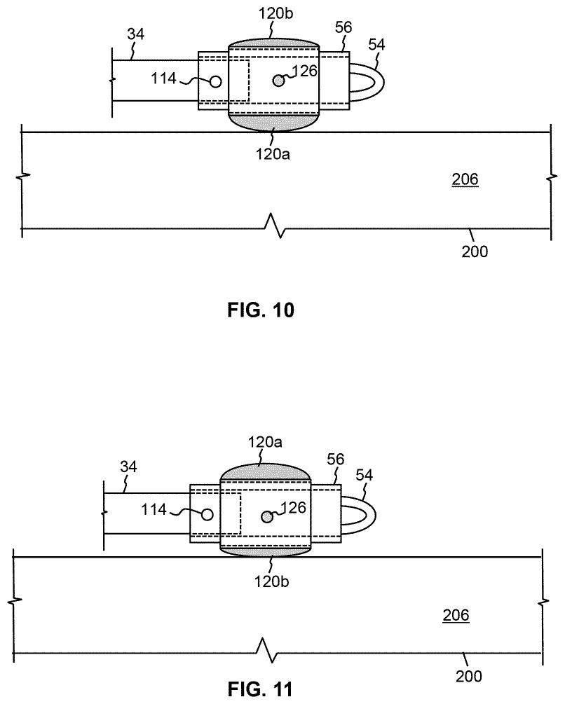

Referring to FIGS. 9 to 10 in this exemplified embodiment, the sleeve member (122) defines an aperture (124) that can be aligned with an aperture (57) defined by the head (56) pull rod (34). The sleeve member (122) and head (56) of pull rod (34) may then be removably attached by insertion of a pin connection (126) through the aligned apertures. FIGS. 5A-5C, as previously described, show pin connections that can be used as non-limiting implementations of the pin connection (126).

In this embodiment, the apparatus (10) includes a first slide member (120a) and a second slide member (120b) attached to a bottom surface and a top surface, respectively, of the sleeve member (122), when in the orientation shown in FIG. 9. In FIG. 10, the sleeve member (122) is installed on the head (56) of the pull rod (34) so that the first slide member (120a) is in sliding contact with the pipeline outer surface (206). The sleeve member (122) may be removed from the head (56) of the pull rod (34), inverted in orientation, and then re-attached to the head (56) of the pull rod (34) in the inverted orientation shown in FIG. 11, so that the second slide member (120b) is in sliding contact with the pipeline outer surface (206).

In this embodiment, the vertical transverse thickness of the first slide member (120a) is greater than the vertical transverse thickness of the second slide member (120b). The different transverse thicknesses of the slide members (120a, 120b) may be used to accommodate pipelines (200) of different outer diameters. For example, when the sleeve member (122) is installed the orientation shown in FIG. 10, the thicker slide member (120a) may be used to contact a pipeline outer surface (206) that is uncoated. In contrast, when the sleeve member (122) is installed the orientation shown in FIG. 11, the thinner slide member (120b) may be used to contact a pipeline outer surface (206) that is coated, and has a larger outer diameter than the pipeline outer surface (206) that is uncoated.

### Example Removable Reducer Attached to Support Member

The following is a description of a removable reducer, and a kit of removable reducers, which can be used in any combination or sub-combination with any other aspect(s) or feature(s) described herein with respect to the apparatus (10).

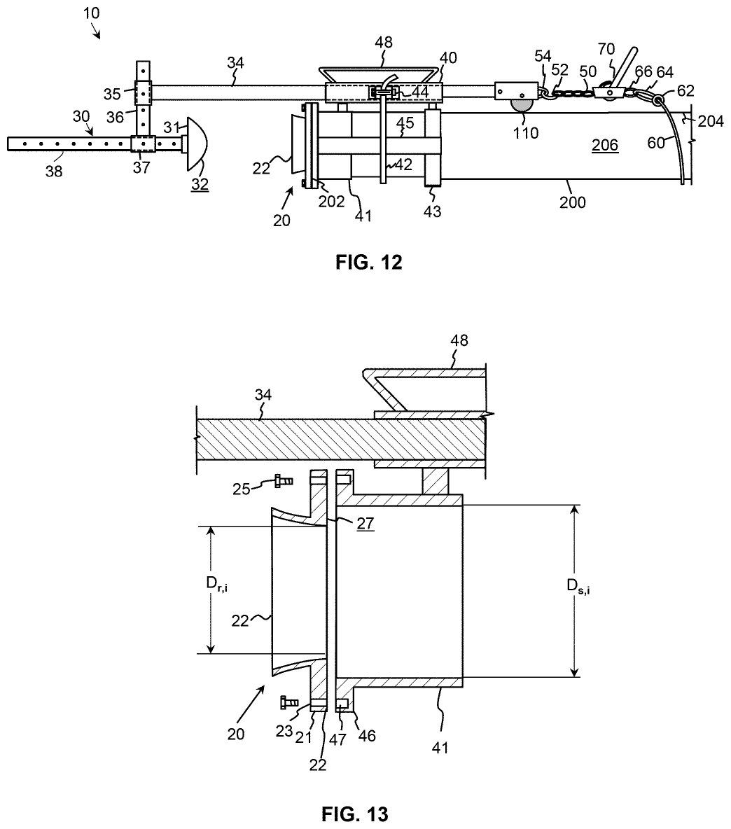

FIG. 12 shows a side view of another embodiment of an apparatus (10) of the present invention for loading a pig (100) into a pipeline (200), when mounted on the pipeline (200). The pig (100) is omitted for clarity, but in use, would be positioned in a manner analogous to that shown in FIG. 1. FIGS. 13 to 16C show portions or parts of this embodiment.

Pipelines used in the oil and gas industry are typically provided in standardized sizes specified by “nominal pipe sizes” determined by the outer diameter of the pipe. Each nominal pipe size is typically available in a variety of “schedules” determined by the wall thickness of the pipe. For example, pipelines having a standard outer diameter of about 75 inches (323.85 mm) may be available in about a dozen different standard wall thicknesses ranging from about 0.156 inches (3.962 mm) to about 1.312 inches (33.325 mm).

This exemplified embodiment of the apparatus (10) allows the apparatus (10) to be used with pipelines of different wall thicknesses, by removable attachment of the reducer (20) to the support member (41). Thus, one reducer (20) may be removed from the support member, and another reducer (20) having a different inner diameter (Dr,i) may be attached to the support member to adapt the apparatus to a pipeline (200) having a different diameter. For example, the apparatus (10) may be provided with a kit, as shown in FIGS. 16A to 16C, of different reducers (20a; 20b; 20c) having different inner diameters (Dr,i,1; Dr,i,2; Dr,i,3), respectively, with Dr,i,1 >Dr,i,2 >Dr,i,3. The reducers (20a, 20b, 20c) may be interchangeably attached to the support member (41).

In this embodiment, referring to FIG. 13, the reducer (20) is removably attached to the support member by way of an annular reducer flange (21), that mates with an annular support member flange (46) formed on the rear end of the rear tubular support member (41). The reducer flange (21) defines a plurality apertures (23) that align with a plurality of threaded receptacles (47) defined by the support member flange (46). Threaded bolts (25) pass through the apertures (23) and mate with the threaded receptacles (47) to removably attach the reducer (20) to the support member (41). In other embodiments, the reducer (20) and support member (41) may be attached by different means. For example, threaded receptacles (47) may be replaced by a non-threaded aperture, and threaded nuts may be used in conjunction with threaded bolts (25) to clamp the reducer flange (21) and the support member flange (46) together. As other examples, the reducer (20) may be releasably attached the support member with means such as a releasable clamp, clip, latch device, or spring-type tension hooks.

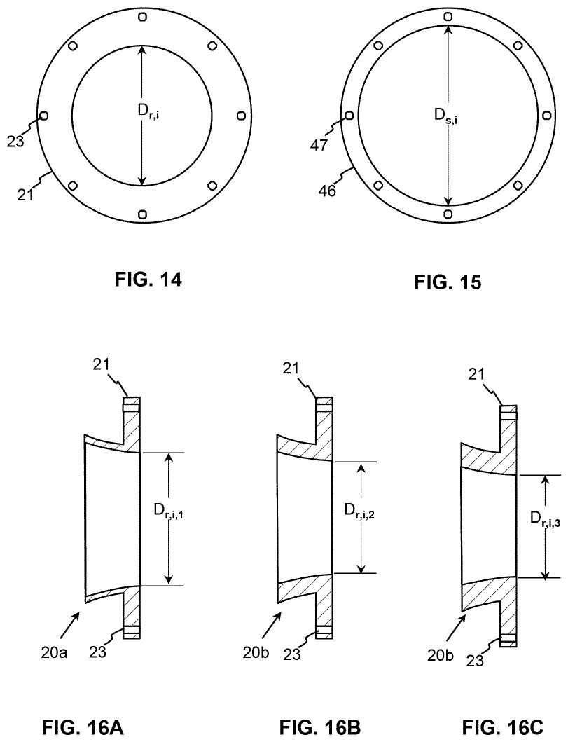

Referring to FIGS. 13 and 14, the inner diameter (Dr,i) of the reducer (20) as measured at its front end (22) may be selected to the closely match the inner diameter of the pipeline (200) as defined by the pipeline inner surface. This permits a smooth transition from inner wall of the reducer (20) to the pipeline inner surface to avoid irregularities that could interfere with the passage of the pig (100) or damage the pig (100). At the same time, referring to FIGS. 13 and 15, the inner diameter (Ds,i) of the tubular sleeve (41) may be selected to the closely match the outer diameter of the pipeline (200) as defined by the pipeline outer surface (206) so that the tubular sleeve (41) can slide over the pipeline (200) within close tolerance.

The inner diameter (Dr, i) of the reducer (20) is smaller than the inner diameter (Ds,i) of the tubular sleeve (41). Accordingly, when the reducer (20) and the tubular sleeve (41) are attached, a portion of the front facing surface (27) (see FIG. 13) at the front end of the reducer (20) is exposed. In use, this exposed portion of the front facing surface (27) is concentrically aligned with the pipeline end (202) and used to bear axially against the pipeline end (202).

### VII. Example Method of Use and Operation of Apparatus

In order to use the embodiment of the apparatus (10) shown in any of FIG. 1, 8 or 12, the apparatus (10) is mounted on the pipeline (200) by sliding the support members (41, 43) onto the pipeline (200). The sling formed by the second cable (60) is looped around the pipeline (200), and the tubular sleeves (41, 43) are slid over the pipeline end (202) such that the reducer (20) is concentrically aligned with the pipeline end (202). The apparatus (10) is advanced axially forward relative to the pipeline (200) until the front end (24) of the reducer (20) abuts and bears axially against the pipeline end (202). The apparatus (10) is secured to the pipeline (200) using the manually operable ratcheting winch (44) to tighten the strap (42) around the pipeline (200). The front end of the pig (100) is manually inserted into the rear end (22) of the reducer (20), and temporarily held therein by friction between the pig (100) and the inner surface of the reducer (20).

If necessary, the transverse position of the pig-engaging surface (32) is adjusted so that the circular pig-engaging surface (32) is concentric with the pig (100). This can be achieved by sliding the intermediate rod (36) within the transversely-extending collar (35) to selectively align one of the apertures of the intermediate rod (36) with an aperture defined by the transversely-extending collar (35), and inserting a pin through the aligned apertures. If necessary, the axial position of the pig-engaging surface (32) is adjusted so that the pig-engaging surface (32) contacts the rear end of the pig (100). This can be achieved by sliding the plunger rod (38) within the axially-extending collar (37) to selectively align one of the apertures defined by the plunger rod (38) with an aperture defined by the axially-extending collar (37), and inserting a pin through the aligned apertures.

The lever of the winch (70) is repeatedly advanced to wind the first cable (50).

Initially, the friction between the pig (100) and the reducer (20) that resists axially forward movement of the pull rod (34) may exceed the friction between the second cable (60) and the pipeline (200) that resists axially rearward movement of the winch (70). If so, winding of the first cable (50) is initially accompanied by axially rearward movement (in FIG. 1, to the left) of the winch (70). As the winch (70) pulls rearwards on the end loop (64) of the second cable (60), the second cable (60) advances through the eyelet (62), causing the sling formed by the second cable (60) to tighten around the pipeline (200). Eventually, the sling constricts the pipeline (200) with sufficient force that friction between the second cable (60) and the pipeline (200) resists further axially rearward movement of the winch (70). At that point, continued winding of the first cable (50) is accompanied by axially forward movement (in FIG. 1, to the right) of the pull rod (34) and the attached pig-engaging surface (32). The pig-engaging surface (32) thereby pushes the pig (100) axially forward through the reducer (20) and the pipeline end (202), thus loading the pig (100) into the pipeline (200). The apparatus (10) may then be dismounted from the pipeline (200) by reversing the foregoing steps for loading the pig (100) and mounting the apparatus (10) on the pipeline (200).

For the embodiment shown in FIG. 1, the rolling member in the form of wheel (80) will eventually engage and roll axially along the pipeline inner surface when the force-transmitting member (30) is advanced axially forward relative to the pipeline (200). This engagement will help to brace the plunger rod (38) of the force-transmitting member (30) against deformation, and thereby help to prevent the plate (31) from coming into contact with the pipeline inner surface and damaging any coatings that may be applied to it.

For the embodiment shown in FIG. 1, the rolling member in the form of wheel (110) engages and rolls axially along the pipeline outer surface (206) when the force-transmitting member (30) is advanced axially forward relative to the pipeline (200). This engagement will help to brace the pull rod (34) of the force-transmitting member (30) against deformation, and thereby help to prevent the pull rod (34) from binding against the guide member (40). It may also prevent the force-transmitting member from scraping against the pipeline outer surface and damaging any coatings that may be applied to it.

For the embodiment shown in FIG. 8, the slide member (120a, or 120b) engages and slides axially along the pipeline outer surface (206) when the force-transmitting member (30) is advanced axially forward relative to the pipeline (200). This engagement will help to brace the pull rod (34) of the force-transmitting member (30) against deformation, and thereby help to prevent the pull rod (34) from binding against the guide member (40). It may also prevent the force-transmitting member from scraping against the pipeline outer surface and damaging any coatings that may be applied to it.

For the embodiment shown in FIG. 12, the apparatus may be supplied with a kit of reducers (20a, 20b, or 20c) as shown in FIGS. 16A to 16C. The reducer (20a, 20b, or 20b) having an inner diameter (Dr,i) that most closely matches the inner diameter of the pipeline inner surface may be attached to the tubular sleeve (41), by bolting together the reducer flange (21) and the support member flange (46). This may be performed before or after mounting the tubular sleeve (41) on the pipeline (200).

### IX. Combination and Sub-Combinations of Feature(s)

It will be appreciated that features of the foregoing embodiments of the apparatus (10) of the present invention may be combined in any combination, or sub-combination, to arrive at additional embodiments of the apparatus of the present invention.

For instance, only by way of illustrative non-limiting example, the removable attachment of the reducer (20) shown in the third embodiment of FIG. 12, may be combined with the slide members (120a, or 120b) of the embodiment of FIG. 8, and the hydraulic cylinder (130, 132) of the embodiment of FIG. 17.

### X. Exemplary Aspects

In view of the described apparatuses, and methods and variations thereof, certain more particularly described aspects of the invention are presented below. These particularly recited aspects should not however be interpreted to have any limiting effect on any different claims containing different or more general teachings described herein, or that the “particular” aspects are somehow limited in some way other than the inherent meanings of the language literally used therein.

Aspect 1A: An apparatus for loading a pig into a pipeline defining an axial forward direction from a pipeline end defining a pipeline opening into a pipeline interior, and a transverse direction perpendicular to the axial direction, and comprising a cylindrical pipeline outer surface extending axially forward from the pipeline end, and a cylindrical pipeline inner surface extending axially forward from the pipeline end, the apparatus comprising: (a) a support member for engaging the cylindrical pipeline outer surface to support the apparatus on the pipeline; (b) a tubular reducer attached to the support member and extending axially from a rear end to a front end configured for concentric alignment with and for bearing axially against the pipeline end, and having an inner diameter that decreases from the rear end to the front end; (c) a force-transmitting member with a pig-engaging surface; (d) a guide member attached to the support member, wherein the guide member engages the force-transmitting member to limit transverse movement of the force-transmitting member relative to the reducer, while permitting the force-transmitting member to move axially forward relative to the reducer such that the pig-engaging surface pushes the pig through the reducer into the pipeline interior; and (e) at least one pipeline-engaging member attached to the force-transmitting member so as to move in unison with the force-transmitting member relative to the reducer, wherein the at least one pipeline engaging member comprises at least one of: (i) an outer pipeline-engaging member disposed to engage the pipeline outer surface, and move axially forward relative to the pipeline, when the force-transmitting member moves axially forward relative to the reducer, and the front end of the reducer is bearing axially against the pipeline end; and (ii) an inner pipeline-engaging member, disposed to engage the pipeline inner surface, and move axially forward relative to the pipeline, when the force-transmitting member moves axially forward relative to the reducer, and the front end of the reducer is bearing axially against the pipeline end.

Aspect 1B: An apparatus for loading a pig into a pipeline defining an axial forward direction from a pipeline end defining a pipeline opening into a pipeline interior, a transverse direction perpendicular to the axial direction, a cylindrical pipeline outer surface extending axially forward from the pipeline end, and comprising a cylindrical inner wall extending axially forward from the pipeline end, the apparatus comprising: (a) a support member for engaging the cylindrical pipeline outer surface to support the apparatus on the pipeline; (b) a first tubular reducer extending axially from a rear end to a front end configured for concentric alignment with and for bearing axially against the pipeline end, and having an inner diameter that decreases from the rear end to the front end, wherein the first reducer is removably attached to the support member; (c) a force-transmitting member with a pig-engaging surface; and (d) a guide member attached to the support member, wherein the guide member engages to the force-transmitting member to limit transverse movement of the force-transmitting member relative to the first reducer, while permitting the force-transmitting member to move axially forward relative to the first reducer such that the pig-engaging surface pushes the pig through the first reducer and into the pipeline interior.

Aspect 1C: An apparatus for loading a pig into a pipeline defining an axial forward direction from a pipeline end defining a pipeline opening into a pipeline interior, a transverse direction perpendicular to the axial direction, a cylindrical pipeline outer surface extending axially forward from the pipeline end, and comprising a cylindrical inner wall extending axially forward from the pipeline end, the apparatus comprising: (a) a support member for engaging the cylindrical pipeline outer surface to support the apparatus on the pipeline; (b) a tubular reducer attached to the support member and extending axially from a rear end to a front end configured for concentric alignment with and for bearing axially against the pipeline end, and having an inner diameter that decreases from the rear end to the front end; (c) a force-transmitting member with a pig-engaging surface; (d) a guide member attached to the support member, wherein the guide member engages the force-transmitting member to limit transverse movement of the force-transmitting member relative to the reducer, while permitting the force-transmitting member to move axially forward relative to the reducer such that the pig-engaging surface pushes the pig through the reducer into the pipeline interior; (e) a hydraulic cylinder comprising a barrel securely attached to the force-transmitting member, and a piston rod movable relative to the barrel; and (f) a cable comprising a first end for direct or indirect attachment to the pipeline, and a second end attached to the piston rod, wherein between the first and second ends, the cable engages the force-transmitting member such that, when the first end is attached to the pipeline, tension in the cable induced by movement of the piston rod relative to the barrel actuates movement of the force-transmitting member in the axially forward direction relative to the reducer.

Aspect 1D: A method for loading a pig into a pipeline defining an axial forward direction from a pipeline end defining a pipeline opening into a pipeline interior, and a transverse direction perpendicular to the axial direction, and comprising a cylindrical pipeline outer surface extending axially forward from the pipeline end, and a cylindrical pipeline inner surface extending axially forward from the pipeline end, the method comprising the steps of: (a) supporting an apparatus of any one of aspects 1A to 1C and 2 to 35 on the pipeline by engaging the support member of the apparatus with the cylindrical pipeline outer surface, with the front end of the tubular reducer of the apparatus abutting against the pipeline end; and (b) moving the force-transmitting member of the apparatus axially forward relative to the reducer such that the pig-engaging surface of the apparatus pushes the pig through the reducer and into the pipeline interior, while the at least one pipeline-engaging member of the apparatus moves in unison with the attached force-transmitting member and engages the pipeline inner surface or the pipeline outer surface to brace the attached force-transmitting member against the pipeline.

Aspect 1E: A method for modifying an apparatus for loading a pig into a pipeline defining an axial forward direction from a pipeline end defining a pipeline opening into a pipeline interior, a transverse direction perpendicular to the axial direction, a cylindrical pipeline outer surface extending axially forward from the pipeline end, and comprising a cylindrical inner wall extending axially forward from the pipeline end, the method comprising the steps of: (a) detaching the first tubular reducer of an apparatus of any one of aspects 1A to 1C and 2 to 35; and (b) removably attaching a second tubular reducer to the support member of the apparatus, wherein the second reducer extends axially from a rear end to a front end configured for concentric alignment with and for bearing axially against the pipeline end, and has an inner diameter that decreases from the rear end to the front end, and wherein the inner diameter of the second reducer at the front end of the second reducer is different from the inner diameter of the first reducer at the front end of first reducer.

Aspect 1F: A method for loading a pig into a pipeline defining an axial forward direction from a pipeline end defining a pipeline opening into a pipeline interior, and a transverse direction perpendicular to the axial direction, and comprising a cylindrical pipeline outer surface extending axially forward from the pipeline end, and a cylindrical pipeline inner surface extending axially forward from the pipeline end, the method comprising the steps of: (a) supporting an apparatus of any one of aspects 1A to 1C and 2 to 35 on the pipeline by engaging the support member of the apparatus with the cylindrical pipeline outer surface, with the front end of the tubular reducer of the apparatus abutting against the pipeline end; (b) securing the first end of the cable of the apparatus to the pipeline; and (c) using a pump to actuate the piston rod to move relative to the barrel of the hydraulic cylinder of the apparatus to induce tension in the cable, and thereby pull the force-transmitting member of the apparatus in the axially forward direction relative to the reducer such that the pig-engaging surface pushes the pig through the reducer and into the pipeline.

Aspect 1G: A kit for loading a pig into a pipeline defining an axial forward direction from a pipeline end defining a pipeline opening into a pipeline interior, a transverse direction perpendicular to the axial direction, a cylindrical pipeline outer surface extending axially forward from the pipeline end, and comprising a cylindrical inner wall extending axially forward from the pipeline end, the apparatus comprising: (a) a support member for engaging the cylindrical pipeline outer surface to support the apparatus on the pipeline; (b) a plurality of removable and interchangeable tubular reducers, each extending axially from a rear end to a front end configured for concentric alignment with and for bearing axially against the pipeline end, and having an inner diameter that decreases from the rear end to the front end, wherein each reducer is removably attached to the support member, wherein each reducer has a different inner diameter at the front end; (c) a force-transmitting member with a pig-engaging surface; and (d) a guide member attached to the support member, wherein the guide member engages to the force-transmitting member to limit transverse movement of the force-transmitting member relative to the reducer, while permitting the force-transmitting member to move axially forward relative to the reducer such that the pig-engaging surface pushes the pig through the reducer and into the pipeline interior.

Aspect 2: The apparatus of any one of Aspects 1A to 1C, the method of any one of Aspects 1D to 1F, the kit of Aspect 1G, wherein the at least one pipeline-engaging member comprises the outer pipeline-engaging member comprising a rolling member rotatably attached to the force-transmitting member for rolling along the pipeline outer surface.

Aspect 3: The apparatus of any one of Aspects 1A to 1C and 2, the method of any one of Aspects 1D to 1F and 2, the kit of Aspect 1G, wherein the rolling member comprises a wheel rotatably supported on an axle attached to the force-transmitting member.

Aspect 4: The apparatus of any one of Aspects 1A to 1C and 2 to 3, the method of any one of Aspects 1D to 1F and 2 to 3, the kit of Aspect 1G, wherein the at least one pipe-line engaging member comprises the inner pipeline-engaging member comprising a rolling member rotatably attached to the force-transmitting member for rolling axially forward along the pipeline outer surface.

Aspect 5: The apparatus of any one of Aspects 1A to 1C and 2 to 4, the method of any one of Aspects 1D to 1F and 2 to 4, the kit of Aspect 1G, wherein the rolling member comprises a wheel rotatably supported on an axle attached to the force-transmitting member.

Aspect 6: The apparatus of any one of Aspects 1A to 1C and 2 to 5, the method of any one of Aspects 1D to 1Fand 2 to 5, the kit of Aspect 1G, wherein the at least one pipeline-engaging member comprises the outer pipeline-engaging member comprising a first slide member attached to the force-transmitting member for sliding axially forward along the pipeline outer surface.

Aspect 7: The apparatus of any one of Aspects 1A to 1C and 2 to 6, the method of any one of Aspects 1D to 1F and 2 to 6, the kit of Aspect 1G, wherein the first slide member comprises a convexly curved surface for engaging the pipeline outer surface.

Aspect 8: The apparatus of any one of Aspects 1A to 1C and 2 to 7, the method of any one of Aspects 1D to 1F and 2 to 7, the kit of Aspect 1G, wherein the first slide member comprises polytetrafluoroethylene.

Aspect 9: The apparatus of any one of Aspects 1A to 1C and 2 to 8, the method of any one of Aspects 1D to 1F and 2 to 8, the kit of Aspect 1G, wherein the first slide member is removably attached to the force-transmitting member.

Aspect 10: The apparatus of any one of Aspects 1A to 1C and 2 to 9, the method of any one of Aspects 1D to 1F and 2 to 9, the kit of Aspect 1G, wherein the first slide member is attached to or forms part of a sleeve member that removably slides onto the force-transmitting member.

Aspect 11: The apparatus of any one of Aspects 1A to 1C and 2 to 10, the method of any one of Aspects 1D to 1F and 2 to 10, the kit of Aspect 1G, wherein the apparatus further comprises a second slide member attached to or forming part of the sleeve member, wherein the first slide member and the second slide member are disposed on different portions of the sleeve member, and wherein the sleeve member is selectively installable onto the portion of the force-transmitting member in both: (a) a first orientation wherein the first slide member engages the pipeline outer surface but the second slide member does not engage the pipeline outer surface; and (b) a second orientation wherein the second slide member engages the pipeline outer surface but the first slide member does not engage the pipeline outer surface.

Aspect 12: The apparatus of any one of Aspects 1A to 1C and 2 to 11, the method of any one of Aspects 1D to 1F and 2 to 11, the kit of Aspect 1G, wherein a transverse thickness of the first slide member is different than a transverse thickness of the second slide member.

Aspect 13: The apparatus of any one of Aspects 1A to 1C and 2 to 12, the method of any one of Aspects 1D to 1F and 2 to 12, the kit of Aspect 1G, wherein the reducer is removably attached to the support member.

Aspect 14: The apparatus of any one of Aspects 1A to 1C and 2 to 13, the method of any one of Aspects 1D to 1F and 2 to 13, the kit of Aspect 1G, wherein the front end of the reducer defines an annular reducer flange that mates with a rear end of the support member when the reducer is attached to the support member.

Aspect 15: The apparatus of any one of Aspects 1A to 1C and 2 to 14, the method of any one of Aspects 1D to 1F and 2 to 14, the kit of Aspect 1G, wherein the support member defines an annular support member flange that mates with the reducer flange.

Aspect 16: The apparatus of any one of Aspects 1A to 1C and 2 to 15, the method of any one of Aspects 1D to 1F and 2 to 15, the kit of Aspect 1G, wherein the support member comprises a tubular sleeve that fits circumferentially around the cylindrical pipeline outer surface.

Aspect 17: The apparatus of any one of Aspects 1A to 1C and 2 to 16, the method of any one of Aspects 1D to 1F and 2 to 16, the kit of Aspect 1G, further comprising a second tubular reducer extending axially from a rear end to a front end configured for concentric alignment with and for bearing axially against the pipeline end, and having an inner diameter that decreases from the rear end to the front end, wherein the second reducer is removably attachable to the support member when the reducer is removed from the support member, and wherein the inner diameter of the second reducer at the front end of the second reducer is different from the inner diameter of the reducer at the front end of reducer.

Aspect 18: The apparatus of any one of Aspects 1A to 1C and 2 to 17, the method of any one of Aspects 1D to 1F and 2 to 17, the kit of Aspect 1G, further comprising a winch, and a cable comprising a first end wrapped around the winch, and a second end attached to the force-transmitting member.

Aspect 19: The apparatus of any one of Aspects 1A to 1C and 2 to 18, the method of any one of Aspects 1D to 1F and 2 to 18, the kit of Aspect 1G, further comprising: (a) a hydraulic cylinder comprising a barrel securely attached to the force-transmitting member, and a piston rod movable relative to the barrel; and (b) a cable comprising a first end for direct or indirect attachment to the pipeline, and a second end attached to the piston rod, wherein between the first and second ends, the cable engages the force-transmitting member such that, when the first end is attached to the pipeline, tension in the cable induced by movement of the piston rod relative to the barrel actuates movement of the force-transmitting member in the axially forward direction relative to the reducer.

Aspect 20: The apparatus of any one of Aspects 1A to 1C and 2 to 19, the method of any one of Aspects 1D to 1F and 2 to 19, the kit of Aspect 1G, further comprising a sling for constricting around the pipeline, and wherein, in use, the first end of the cable is attached to the pipeline via attachment to the sling.

Aspect 21: The apparatus of any one of Aspects 1A to 1C and 2 to 20, the method of any one of Aspects 1D to 1F and 2 to 20, the kit of Aspect 1G, wherein the force-transmitting member comprises a sheave, and the cable engages the force-transmitting member via the sheave.

Aspect 22: The apparatus of any one of Aspects 1A to 1C and 2 to 21, the method of any one of Aspects 1D to 1F and 2 to 21, the kit of Aspect 1G, wherein the force-transmitting member comprises a tubular portion, and wherein either the barrel, or the piston rod, or both the barrel and the piston rod are contained in the tubular portion.

Aspect 23: The apparatus of any one of Aspects 1A to 1C and 2 to 22, the method of any one of Aspects 1D to 1F and 2 to 22, the kit of Aspect 1G, wherein the front end of the first reducer defines an annular reducer flange that mates with a rear end of the support member when the reducer is attached to the support member.

Aspect 24: The apparatus of any one of Aspects 1A to 1C and 2 to 23, the method of any one of Aspects 1D to 1F and 2 to 23, the kit of Aspect 1G, wherein the support member defines an annular support member flange that mates with the reducer flange.

Aspect 25: The apparatus of any one of Aspects 1A to 1C and 2 to 24, the method of any one of Aspects 1D to 1F and 2 to 24, the kit of Aspect 1G, wherein the support member comprises a tubular sleeve that fits circumferentially around the cylindrical pipeline outer surface.

Aspect 26: The apparatus of any one of Aspects 1A to 1C and 2 to 25, the method of any one of Aspects 1D to 1F and 2 to 25, the kit of Aspect 1G, further comprising a second tubular reducer extending axially from a rear end to a front end configured for concentric alignment with and for bearing axially against the pipeline end, and having an inner diameter that decreases from the rear end to the front end, wherein the second reducer is removably attachable to the support member when the first reducer is removed from the support member, and wherein the inner diameter of the second reducer at the front end of the second reducer is different from the inner diameter of the first reducer at the front end of first reducer.

Aspect 27: The apparatus of any one of Aspects 1A to 1C and 2 to 26, the method of any one of Aspects 1D to 1F and 2 to 26, the kit of Aspect 1G, further comprising a winch, and a cable comprising a first end wrapped around the winch, and a second end attached to the force-transmitting member.

Aspect 28: The apparatus of any one of Aspects 1A to 1C and 2 to 27, the method of any one of Aspects 1D to 1F and 2 to 27, the kit of Aspect 1G, further comprising: (a) a hydraulic cylinder comprising a barrel securely attached to the force-transmitting member, and a piston rod movable relative to the barrel; and (b) a cable comprising a first end for direct or indirect attachment to the pipeline, and a second end attached to the piston rod, wherein between the first and second ends, the cable engages the force-transmitting member such that, when the first end is attached to the pipeline, tension in the cable induced by movement of the piston rod relative to the barrel actuates movement of the force-transmitting member in the axially forward direction relative to the reducer.

Aspect 29: The apparatus of any one of Aspects 1A to 1C and 2 to 28, the method of any one of Aspects 1D to 1F and 2 to 28, the kit of Aspect 1G, further comprising a sling for constricting around the pipeline, and wherein, in use, the first end of the cable is attached to the pipeline via attachment to the sling.

Aspect 30: The apparatus of any one of Aspects 1A to 1C and 2 to 29, the method of any one of Aspects 1D to 1F and 2 to 29, the kit of Aspect 1G, wherein the force-transmitting member comprises a sheave, and the cable engages the force-transmitting member via the sheave.

Aspect 31: The apparatus of any one of Aspects 1A to 1C and 2 to 30, the method of any one of Aspects 1D to 1F and 2 to 30, the kit of Aspect 1G, wherein the force-transmitting member comprises a tubular portion, and wherein either the barrel, or the piston rod, or both the barrel and the piston rod are contained in the tubular portion.

Aspect 32: The apparatus of any one of Aspects 1A to 1C and 2 to 31, the method of any one of Aspects 1D to 1F and 2 to 31, the kit of Aspect 1G, wherein threaded bolts are used to removably attach the second tubular reducer to the support member of the apparatus.

Aspect 33: The apparatus of any one of Aspects 1A to 1C and 2 to 32, the method of any one of Aspects 1D to 1F and 2 to 32, the kit of Aspect 1G, further comprising a sling for constricting around the pipeline, and wherein, in use, the first end of the cable is attached to the pipeline via attachment to the sling.

Aspect 34: The apparatus of any one of Aspects 1A to 1C and 2 to 33, the method of any one of Aspects 1D to 1F and 2 to 33, the kit of Aspect 1G, wherein the force-transmitting member comprises a sheave, and the cable engages the force-transmitting member via the sheave.

Aspect 35: The apparatus of any one of Aspects 1A to 1C and 2 to 34, the method of any one of Aspects 1D to 1F and 2 to 34, the kit of Aspect 1G, wherein the force-transmitting member comprises a tubular portion, and wherein either the barrel, or the piston rod, or both the barrel and the piston rod are contained in the tubular portion.

Aspect 36: An apparatus comprising or consisting essentially of any combination of elements or features disclosed herein.

Aspect 37: A method comprising any combination of steps, elements or features disclosed herein.

XI. Interpretation

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. An apparatus for loading a pig into a pipeline defining an axial forward direction from a pipeline end defining a pipeline opening into a pipeline interior, and a transverse direction perpendicular to the axial direction, and comprising a cylindrical pipeline outer surface extending axially forward from the pipeline end, and a cylindrical pipeline inner surface extending axially forward from the pipeline end, the apparatus comprising:
(a) a support member for engaging the cylindrical pipeline outer surface to support the apparatus on the pipeline;
(b) a tubular reducer attached to the support member and extending axially from a rear end to a front end configured for concentric alignment with and for bearing axially against the pipeline end, and having an inner diameter that decreases from the rear end to the front end;
(c) a force-transmitting member with a pig-engaging surface;
(d) a guide member attached to the support member, wherein the guide member engages the force-transmitting member to limit transverse movement of the force-transmitting member relative to the reducer, while permitting the force-transmitting member to move axially forward relative to the reducer such that the pig-engaging surface pushes the pig through the reducer into the pipeline interior; and
(e) at least one pipeline-engaging member attached to the force-transmitting member so as to move in unison with the force-transmitting member relative to the reducer, wherein the at least one pipeline engaging member comprises at least one of:
an outer pipeline-engaging member disposed to engage the pipeline outer surface, and move axially forward relative to the pipeline, when the force-transmitting member moves axially forward relative to the reducer, and the front end of the reducer is bearing axially against the pipeline end; and
(ii) an inner pipeline-engaging member, disposed to engage the pipeline inner surface, and move axially forward relative to the pipeline, when the force-transmitting member moves axially forward relative to the reducer, and the front end of the reducer is bearing axially against the pipeline end.

2. The apparatus of claim 1, wherein one or both of the inner and outer pipeline-engaging member comprises a rolling member rotatably attached to the force-transmitting member for rolling along the pipeline outer surface.

3. The apparatus of claim 2, wherein the rolling member comprises a wheel rotatably supported on an axle attached to the force-transmitting member.

4. The apparatus of claim 1, wherein the at least one pipeline-engaging member comprises the outer pipeline-engaging member comprising a first slide member attached to the force-transmitting member for sliding axially forward along the pipeline outer surface,
wherein, optionally, the first slide member comprises a convexly curved surface for engaging the pipeline outer surface.

5. The apparatus of claim 4, wherein the first slide member is removably attached to the force-transmitting member.

6. The apparatus of claim 5, wherein the first slide member is attached to or forms part of a sleeve member that removably slides onto the force-transmitting member.

7. The apparatus of claim 6, wherein the apparatus further comprises a second slide member attached to or forming part of the sleeve member, wherein the first slide member and the second slide member are disposed on different portions of the sleeve member, and wherein the sleeve member is selectively installable onto the portion of the force-transmitting member in both:
(a) a first orientation wherein the first slide member engages the pipeline outer surface but the second slide member does not engage the pipeline outer surface; and
(b) a second orientation wherein the second slide member engages the pipeline outer surface but the first slide member does not engage the pipeline outer surface.

8. The apparatus of claim 7, wherein a transverse thickness of the first slide member is different than a transverse thickness of the second slide member.

9. The apparatus of claim 1, wherein the reducer is removably attached to the support member.

10. The apparatus of claim 9, wherein the front end of the reducer defines an annular reducer flange that mates with a rear end of the support member when the reducer is attached to the support member.

11. The apparatus of claim 10, wherein the support member defines an annular support member flange that mates with the reducer flange.

12. The apparatus of claim 9, wherein the support member comprises a tubular sleeve that fits circumferentially around the cylindrical pipeline outer surface.

13. The apparatus of claim 9, further comprising a second tubular reducer extending axially from a rear end to a front end configured for concentric alignment with and for bearing axially against the pipeline end, and having an inner diameter that decreases from the rear end to the front end, wherein the second reducer is removably attachable to the support member when the reducer is removed from the support member, and wherein the inner diameter of the second reducer at the front end of the second reducer is different from the inner diameter of the reducer at the front end of reducer.

14. The apparatus of claim 1, further comprising a winch, and a cable comprising a first end wrapped around the winch, and a second end attached to the force-transmitting member.

15. The apparatus of claim 1, further comprising:
(a) a hydraulic cylinder comprising a barrel securely attached to the force-transmitting member, and a piston rod movable relative to the barrel; and
(d) a cable comprising a first end for direct or indirect attachment to the pipeline, and a second end attached to the piston rod, wherein between the first and second ends, the cable engages the force-transmitting member such that, when the first end is attached to the pipeline, tension in the cable induced by movement of the piston rod relative to the barrel actuates movement of the force-transmitting member in the axially forward direction relative to the reducer.

16. The apparatus of claim 15, further comprising a sling for constricting around the pipeline, and wherein, in use, the first end of the cable is attached to the pipeline via attachment to the sling.

17. The apparatus of claim 15, wherein the force-transmitting member comprises at least one of:
(a) a sheave, and the cable engages the force-transmitting member via the sheave; and
(b) a tubular portion, and wherein either the barrel, or the piston rod, or both the barrel and the piston rod are contained in the tubular portion.

18. A method for loading a pig into a pipeline defining an axial forward direction from a pipeline end defining a pipeline opening into a pipeline interior, and a transverse direction perpendicular to the axial direction, and comprising a cylindrical pipeline outer surface extending axially forward from the pipeline end, and a cylindrical pipeline inner surface extending axially forward from the pipeline end, the method comprising the steps of:
(a) supporting an apparatus of claims 1 on the pipeline by engaging the support member of the apparatus with the cylindrical pipeline outer surface, with the front end of the tubular reducer of the apparatus abutting against the pipeline end; and
(b) moving the force-transmitting member of the apparatus axially forward relative to the reducer such that the pig-engaging surface of the apparatus pushes the pig through the reducer and into the pipeline interior, while the at least one pipeline-engaging member of the apparatus moves in unison with the attached force-transmitting member and engages the pipeline inner surface or the pipeline outer surface to brace the attached force-transmitting member against the pipeline.

19. The method of claim 18, wherein the apparatus further comprises a second tubular reducer extending axially from a rear end to a front end configured for concentric alignment with and for bearing axially against the pipeline end, and having an inner diameter that decreases from the rear end to the front end, wherein the second reducer is removably attachable to the support member when the reducer is removed from the support member, and wherein the inner diameter of the second reducer at the front end of the second reducer is different from the inner diameter of the reducer at the front end of reducer, further comprising:
(a) detaching the second tubular reducer; and
(b) removably attaching a second tubular reducer to the support member of the apparatus, wherein the second reducer extends axially from a rear end to a front end configured for concentric alignment with and for bearing axially against the pipeline end, and has an inner diameter that decreases from the rear end to the front end, and wherein the inner diameter of the second reducer at the front end of the second reducer is different from the inner diameter of the first reducer at the front end of first reducer.

20. The method of claim 18, further comprising:
(a) supporting an apparatus of claims 1 on the pipeline by engaging the support member of the apparatus with the cylindrical pipeline outer surface, with the front end of the tubular reducer of the apparatus abutting against the pipeline end;
(b) securing the first end of the cable of the apparatus to the pipeline; and
(c) using a pump to actuate the piston rod to move relative to the barrel of the hydraulic cylinder of the apparatus to induce tension in the cable, and thereby pull the force-transmitting member of the apparatus in the axially forward direction relative to the reducer such that the pig-engaging surface pushes the pig through the reducer and into the pipeline.
